(19) United States
(12) Patent Application Publication
(10) Pub. No.: US 2019/0391718 A1
(43) Pub. Date: Dec. 26, 2019

(54) SYSTEM AND METHOD FOR MANAGING A SCROLLING OPERATION

(71) Applicant: MZ IP Holdings, LLC, Palo Alto, CA (US)

(72) Inventors: Bingjie Cao, Fremont, CA (US); Brian Le, San Jose, CA (US); Shutong Yu, Belmont, CA (US)

(21) Appl. No.: 16/444,455

(22) Filed: Jun. 18, 2019

Related U.S. Application Data
(60) Provisional application No. 62/689,901, filed on Jun. 26, 2018.

(51) Int. Cl. G06F 3/0485; G06F 3/0482; G06F 3/0481

(52) U.S. Cl. CPC G06F 3/0485; G06F 3/04812; G06F 3/0482

(57) ABSTRACT

A method, a system, and an article are provided for managing a scrolling operation on a computer display. An example method can include: providing a plurality of cells for presenting graphical elements on a user device; advancing a sequence of the cells through a visible area on a display of the user device; moving a first cell that is no longer within the visible area to one of a plurality of cell recycle pools; moving a second cell from one of the plurality of cell recycle pools to a cell generation area; generating a graphical element for the second cell within the cell generation area; and advancing the second cell from the cell generation area into the visible area on the display of the user device.

### CROSS-REFERENCE TO RELATED APPLICATIONS

This application claims the benefit of U.S. Provisional Patent Application No. 62/689,901, filed Jun. 26, 2018, the entire contents of which are incorporated by reference herein.

### BACKGROUND

The present disclosure relates to presenting graphical elements on a display and, in certain examples, to systems and methods for managing a scrolling operation on the display.

In general, a website, software application, or computer file can include graphical content for presentation on a display of a computing device, such as a smartphone, tablet computer, or other mobile device. When a size of the display is less than a size of the graphical content, the display may present only a portion of the content. In such an instance, a user of the device can provide input to move or reposition the content on the display, so other portions of the content can be viewed. A graphical user interface on the device can include a scrollbar that allows the user to scroll through the content on the display in a predetermined direction. Alternatively, the user can scroll through the content by swiping a touchscreen or rotating a scroll wheel on an input device, such as a mouse. Scrolling can allow the user to view all the available content, even though only a portion of the content may be visible on the display at any given time.

### SUMMARY

In general, the subject matter of this disclosure relates to systems and methods for enabling users to scroll through graphical items on a display of a computing device, such as a mobile device. The graphical items can be presented using a sequence of cells, which can occupy adjacent rows or columns on the display. When a user provides input to scroll through the sequence of cells, the cells can be advanced through a visible area of the display. When a first cell advances to a location that is no longer visible on the display, the first cell can be moved to a cell recycle pool where the cell can be stored for subsequent reuse. For example, as the user continues to scroll through the sequence of cells, a new cell may need to be generated or rendered before the new cell can be displayed. To generate the new cell, a recycled cell can be retrieved from the cell recycle pool and moved to a cell generation area, where the new cell can be rendered from the recycled cell. For example, the recycled cell may be or include a cell template, and one or more graphical elements can be added to the recycled cell. Once the new cell has been generated, the new cell can be advanced into the visible area of the display. Additional cells can be recycled and reused in this manner, as needed, while the user continues to scroll through the sequence of cells.

Advantageously, the systems and methods described herein are able to significantly improve the speed, memory usage, and computational efficiency associated with scrolling operations on graphical displays. When a new cell will be rendered, for example, the systems and methods can reuse an old cell to generate the new cell. This avoids having to generate new cells or cell templates on the fly or from scratch each time a new cell will be displayed, and avoids having to reserve or otherwise allocate substantial amounts of memory to display a large number of graphical elements with, for example, hundreds or thousands of cells. In preferred implementations, the systems and methods described herein are able to store and reuse multiple cell types or cell templates, including cells having different sizes, layouts, shapes, textures, and/or other cell features. This can allow the systems and methods to efficiently manage scrolling operations for cell sequences having a variety of cell shapes, sizes, graphical elements, and/or configurations.

Additionally or alternatively, in some examples, a user may wish to advance the display quickly or immediately from one cell location to another cell location (e.g., at an opposite end of the cell sequence). To achieve this, the systems and methods can estimate a distance between the two cells (e.g., a linear scrolling distance along the display) and can advance the display according to the estimated distance. The estimated distance can be based on, for example, an average height of a subset of cells from the sequence, such as an initial group of cells that have already been displayed or rendered. By estimating the distance in such a manner, the systems and methods can avoid having to create or render some or all intermediate cells between the two cell locations to determine a height for each of these cells. This approach of estimating the distance based on an average height can significantly improve computational efficiency associated with advancing from one cell location to another cell location, which can be 100, 500, 1000, or more cells away, when cell sequences are large.

In one aspect, the subject matter described in this specification relates to a method (e.g., a computer-implemented method). The method includes: providing a plurality of cells for presenting graphical elements on a user device; advancing a sequence of the cells through a visible area on a display of the user device; moving a first cell that is no longer within the visible area to one of a plurality of cell recycle pools; moving a second cell from one of the plurality of cell recycle pools to a cell generation area; generating a graphical element for the second cell within the cell generation area; and advancing the second cell from the cell generation area into the visible area on the display of the user device.

In certain examples, the cells can include multiple templates, with each template having a unique arrangement of graphical elements. Each cell recycle pool in the plurality of cell recycle pools can correspond to a respective template from the multiple templates. Advancing the sequence of the cells can include receiving an instruction from a user of the device to scroll through the cells on the display. Advancing the sequence of the cells can include presenting a portion of the sequence of the cells on the display. The cell generation area can be adjacent to or proximate the visible area.

In some instances, moving the first cell can include moving the first cell from a recycle area proximate the cell generation area. Advancing the sequence of cells can include: estimating a distance within the sequence of cells to a third cell; and advancing the sequence of cells through the visible area by the estimated distance. Estimating the distance can include: determining an average height for a subset of cells in the sequence; and calculating the estimated distance based on the average height. Advancing the sequence of cells by the estimated distance can include moving the third cell into the visible area on the display.

In another aspect, the subject matter described in this specification relates to a system having one or more computer processors programmed to perform operations including: providing a plurality of cells for presenting graphical elements on a user device; advancing a sequence of the cells through a visible area on a display of the user device; moving a first cell that is no longer within the visible area to one of a plurality of cell recycle pools; moving a second cell from one of the plurality of cell recycle pools to a cell generation area; generating a graphical element for the second cell within the cell generation area; and advancing the second cell from the cell generation area into the visible area on the display of the user device.

In various implementations, the cells can include multiple templates, with each template having a unique arrangement of graphical elements. Each cell recycle pool in the plurality of cell recycle pools can correspond to a respective template from the multiple templates. Advancing the sequence of the cells can include receiving an instruction from a user of the device to scroll through the cells on the display. Advancing the sequence of the cells can include presenting a portion of the sequence of the cells on the display. The cell generation area can be adjacent to or proximate the visible area.

In certain instances, moving the first cell can include moving the first cell from a recycle area proximate the cell generation area. Advancing the sequence of cells can include: estimating a distance within the sequence of cells to a third cell; and advancing the sequence of cells through the visible area by the estimated distance. Estimating the distance can include: determining an average height for a subset of cells in the sequence; and calculating the estimated distance based on the average height. Advancing the sequence of cells by the estimated distance can include moving the third cell into the visible area on the display.

In another aspect, the subject matter described in this specification relates to an article. The article includes a non-transitory computer-readable medium having instructions stored thereon that, when executed by one or more computer processors, cause the one or more computer processors to perform operations including: providing a plurality of cells for presenting graphical elements on a user device; advancing a sequence of the cells through a visible area on a display of the user device; moving a first cell that is no longer within the visible area to one of a plurality of cell recycle pools; moving a second cell from one of the plurality of cell recycle pools to a cell generation area; generating a graphical element for the second cell within the cell generation area; and advancing the second cell from the cell generation area into the visible area on the display of the user device.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing a scrolling operation on a display of a user device.

FIG. 2 is a screenshot for a computer display presenting an example sequence of cells containing graphical elements.

FIG. 3 is a schematic diagram of an example sequence of cells and a plurality of cell recycle pools for scrolling through graphical elements on a display.

FIG. 4 is a schematic diagram of an example sequence of cells for presenting graphical elements on a display of a user device.

FIG. 5 is a flowchart of an example method of managing a scrolling process on a display of a user device.

### DETAILED DESCRIPTION

In general, the systems and methods described herein relate to presenting graphical elements on a display of a user device and, in particular, to scrolling through the graphical elements on the display. The graphical elements are typically presented in a sequence or collection of cells arranged in rows or columns. As a user scrolls through the cells on the user device, cells that move off the display and are no longer visible can be reused or recycled to generate new cells that become visible as the user continues to scroll. This approach of recycling cells can save memory and improve scrolling performance.

In some instances, for example, as a user scrolls through a sequence of cells, new cells can be generated from recycled cells (e.g., from one or more cell recycle pools) by filling in or rendering the recycled cells with graphical elements (e.g., images, text, and/or data) corresponding to the new cells (e.g., based on indices for the new cells). Cells that move out of view can be recycled and dropped back into the cell recycle pool.

Additionally or alternatively, the systems and methods described herein can support fast random access to cells that are not presently shown on the display, such as cells at a very bottom (or top) in a long sequence of cells. This can involve, for example, skipping or jumping over cells in a middle of the sequence. In some examples, target indices for a desired cell can be displayed in an estimated position. The estimated position for the cell can be calculated based on an average cell size, such as an average size of cells that have already been rendered or displayed.

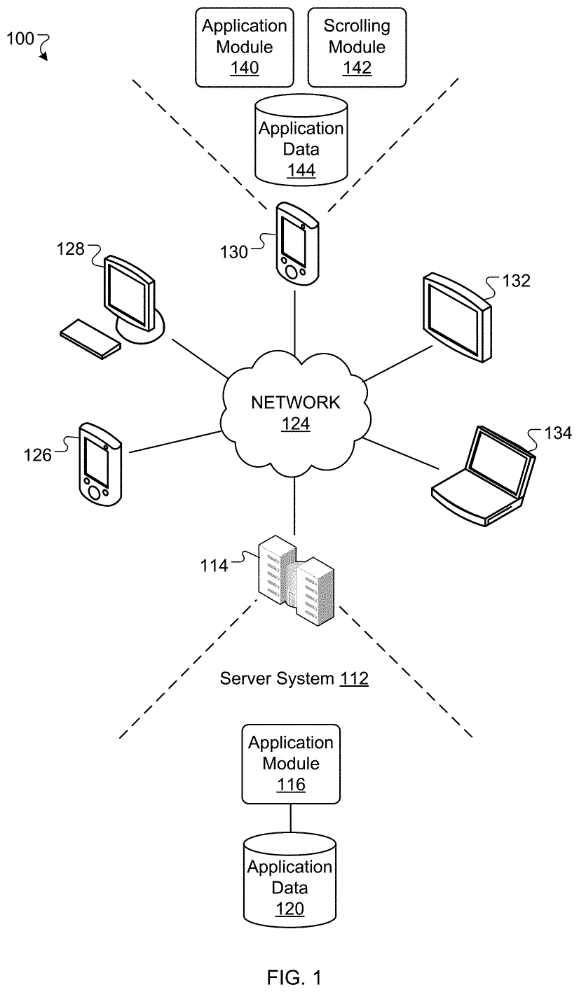

FIG. 1 illustrates an example system 100 for managing a scrolling process for a computer display. A server system 112 provides functionality for supporting a client application or other software application provided to a plurality of users. The server system 112 includes software components and databases that can be deployed at one or more data centers 114 in one or more geographic locations, for example. In certain instances, the server system 112 is, includes, or utilizes a content delivery network (CDN). The server system 112 software components can include an application module 116 and/or can include subcomponents that can execute on the same or on different individual data processing apparatus. The server system 112 databases can include an application data 120 database. The databases can reside in one or more physical storage systems. The software components and data will be further described below.

The client application can be provided as an end-user application to allow users to interact with the server system 112. The client application or components thereof can be accessed through a network 124 (e.g., the Internet) by users of client devices, such as a smart phone 126, a personal computer 128, a smart phone 130, a tablet computer 132, and a laptop computer 134. Other client devices are possible.

Each client device in the system 100 can utilize or include software components and databases for the client application. The software components on the client devices can include an application module 140 and a scrolling module 142. The application module 140 can implement the client application on each client device. The scrolling module 142 can enable users to scroll through graphical items presented on the client devices 126, 128, 130, 132, and 134. The graphical items can be presented in a sequence or collection of cells, as described herein. Cells that are no longer being viewed can be reused or recycled to generate new cells. The databases on the client devices can include an application data 144 database, which can include data used by the client application and/or can include one or more cell recycle pools, which can store recycled cells for use in generating new cells. While the application module 140, the scrolling module 142, and the application data 144 database are depicted as being associated with the smart phone 130, it is understood that other client devices (e.g., the smart phone 126, the personal computer 128, the tablet computer 132, and/or the laptop computer 134) can include the application module 140, the scrolling module 142, the application data 144 database, and any portions thereof. Additionally or alternatively, it is understood that the scrolling module 142 or any portion thereof can be implemented on the server system 112.

Still referring to FIG. 1, the application module 116 can include software components that support the client application by, for example, performing calculations, implementing software updates, exchanging information or data with the application module 140 and/or the scrolling module 142, assisting with the initialization of the client application, and/or monitoring an overall status of the client application. The application data 120 database can store and provide files and/or data for the client application. The files and/or data can include, for example, startup files, runtime files, user data, image data, video data, lists of files, and/or any other files or data that can be used by the server system 112 and/or client devices to run the client application or other software application (e.g., a web-based application). In certain instances, for example, the application module 116 can retrieve files or data (e.g., video data or image data) from the application data 120 database and send the data to client devices during a startup phase and/or a runtime phase of the client application.

The client application implemented on the client devices 126, 128, 130, 132, and 134 can relate to and/or provide a wide variety of functions and information, including, for example, entertainment (e.g., a game, music, videos, etc.), business (e.g., word processing, accounting, spreadsheets, etc.), news, weather, finance, sports, etc. In certain instances, the client application provides a multi-player online game.

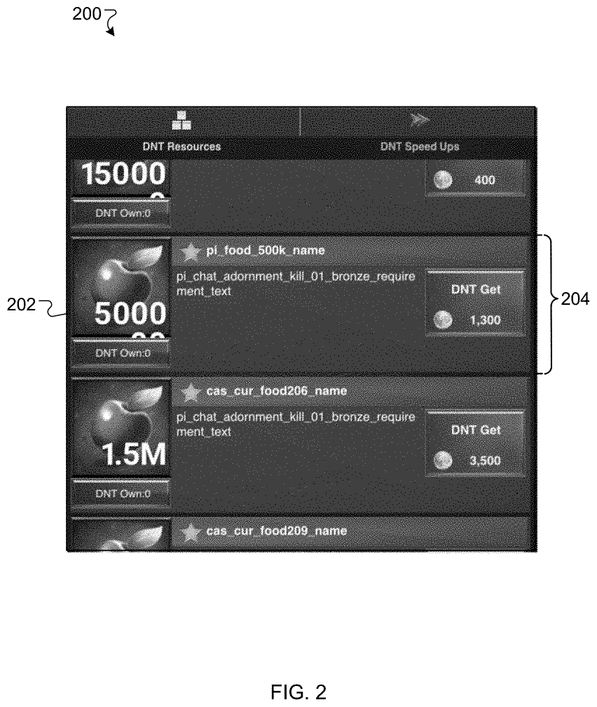

In various examples, the scrolling module 142 can use any suitable number of cells to display images, text, or other suitable types of graphical elements or objects on user devices, such as the client devices 126, 128, 130, 132, and 134, and/or smartphones, tablets, or other mobile or computing devices. A “cell” can be a rendered image block or a template for a rendered image block that is configured to present a graphical item or data. The template can be or include a code block having or defining a graphical element layout and/or functionality for the cell. For purposes of illustration and not limitation, FIG. 2 illustrates a sequence 200 of graphical items being presented on a display 202 of a user device. Each row or block in the sequence 200 can be or include a cell 204.

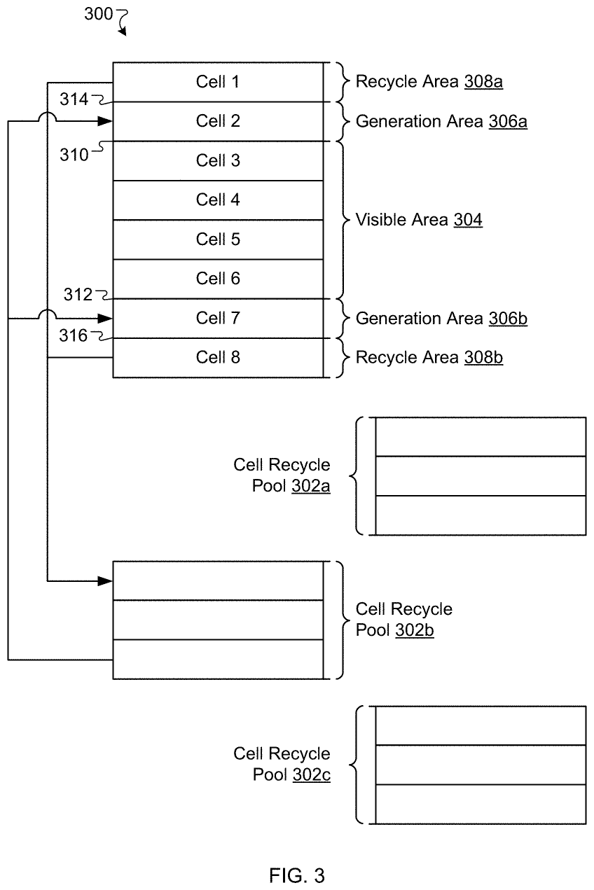

FIG. 3 includes a schematic diagram showing an exemplary sequence 300 of cells that can be scrolled through a display of a user device according to the present invention. Merely for purposes of illustration and not limitation, the sequence 300 includes eight cells (Cell 1, Cell 2, Cell 3, . . . , and Cell 8) and three accompanying cell recycle pools 302a, 302b, and 302c, each containing three cells. Other numbers of cells can be included in the sequence 300 and/or the cell recycle pools 302a, 302b, and 302c, and any suitable number of cell recycle pools can be used.

In the depicted example, a portion of the cells (Cells 3-6) in the sequence 300 reside in a visible area 304, another portion of the cells (Cells 2 and 7) reside in cell generation areas 306a and 306b, and another portion of the cells (Cells 1 and 8) reside in cell recycle areas 308a and 308b. In general, the visible area 304 corresponds to a viewport or a display through which graphical objects can be displayed to a user of the user device. Cells that reside in the visible area 304 can be presented fully or partially on the display and/or can be visible to the user. Due to varying cell sizes, boundaries of the display may not correspond exactly to boundaries of the visible area 304. For example, while the visible area 304 may include an integer number of cells (e.g., 4), the display size may correspond to a non-integer number of cells (e.g., 3.7), depending on the sizes of the cells residing in the visible area 304. A scroll bar for the display can be analog, for example, such that the display can present portions of cells, rather than requiring each cell to be fully displayed.

In the depicted example, the cell generation areas 306a and 306b can be adjacent to or proximate the visible area 304. For example, cell generation area 306a can be located at a top boundary 310 of the visible area 304, while cell generation area 306b can be located at a bottom boundary 312 of the visible area 304. Likewise, the cell recycle areas 308a and 308b can be adjacent to or proximate the cell generation areas 306a and 306b, respectively, such that the cell generation areas 306a and 306b can be located between the visible area 304 and the cell recycle areas 308a and 308b, respectively. For example, cell recycle area 308a can be located at a top boundary 314 of cell generation area 306a, while cell recycle area 308b can be located at a bottom boundary 316 of cell generation area 306b. It is noted that any or all of the cell generation areas 306a and 306b and the cell recycle areas 308a and 308b can include any suitable number of cells. Additionally or alternatively, the cell recycle pools 302a, 302b, and 302c can include any suitable number of cells. The recycled cells in the cell recycle pools 302a, 302b, and 302c can be used to support the use or generation of cells in the cell generation areas 306a and 306b for eventual display in the viewport. In some instances, for example, a newly created cell or a cell in one of the recycle pools 302a, 302b, or 302c can include only layout information, which can define a size and shape of the cell and/or sizes, shapes, and/or locations for graphical elements within the cell. The cell can be formatted with data (e.g., text, images, colors, textures, animations, etc.) in one of the cell generation areas 306a or 306b. Such data can be removed from the cell in one of the cell recycle areas 308a or 308b.

In a typical example, as a user scrolls through the display, cells in the sequence 300 can pass through the visible area 304 and graphical objects associated with the cells can move along the display and can enter or leave the display. For example, a cell can be rendered or created when an index for the cell (or a graphical element corresponding to the cell) lands in either cell generation area 306a (when the user is scrolling up) or cell generation area 306b (when the user is scrolling down). Cell creation can involve reusing cells or cell templates from one or more of the cell recycle pools 302a, 302b, and 302c. For example, a cell from cell recycle pool 302b can be added to either cell generation area 306a or cell generation 306b, as shown in FIG. 3. Alternatively or additionally, when the cell recycle pools 302a, 302b, and 302c include no available or suitable cells, a new cell can be created for use in cell generation area 306a and/or cell generation 306b, without using a recycled cell.

As the user continues to scroll through the display, various graphical objects can exit the display and cells associated with the graphical objects can be recycled for later use. For example, when an index for a cell (or a graphical element corresponding to the cell) lands in either cell recycle area 308a (when the user is scrolling down) or cell recycle area 308b (when the user is scrolling up), the cell can be moved from recycle area 308a or cell recycle area 308b, respectively, to cell recycle pool 302b, as shown in FIG. 3, or to a different cell recycle pool. Before recycled cells are dropped into the cell recycle pools 302a, 302b, and 302c, one or more resources in the recycled cells may be scrubbed or cleaned up. For example, if a timer is displaying in a cell that is to be recycled, then the timer can be stopped before the cell is moved into one of the cell recycle pools 302a, 302b, or 302c. Alternatively or additionally, animations or visual effects running for a cell that is no longer displayed can be stopped or removed (e.g., by calling an engine function), to avoid wasting central processing unit (CPU) time on such resources.

In various examples, each cell in the sequence 300 can be assigned a cell index, and each index can be associated with data that defines features for the cell, such as, for example, a cell template, a cell layout, a cell format, cell graphical elements or objects, text, cell sizes (e.g., dimensions), and/or other cell features. For example, Cell 1 and Cell 2 can be assigned cell indices 1 and 2, respectively, and each of these indices can be associated with data describing the content, sizes, and/or other features for these cells. The data for the cells can be organized in an array or matrix, for example, with elements in the first row having data for Cell 1, at index 1. For example, the first, second, and third elements in the first row of the matrix can define a cell template, a cell size, and a graphical object for Cell 1. In some instances, when a cell will be rendered for a certain index, a recycled cell can be popped or retrieved from one of the cell recycle pools 302a, 302b, or 302c and reformatted according to the data at the index.

In certain implementations, the cells in the sequence 300 and/or in the cell recycle pools 302a, 302b, and 302c can have or include a wide variety of cell formats, such as different cell sizes, arrangements of graphical elements, colors, text, textures, etc. The format of each cell can be defined by data associated with the cell, which can include, for example, a template identifier value or field that defines the format or layout for the cell. In some examples, the template identifier for a cell can be linked to an HTML (Hypertext Markup Language) template, an RML (Rocket Markup Language) template, or similar template (e.g., based on a document-markup language) that defines the cell layout. Additionally or alternatively, cells can be recycled according to the cell templates. For example, each cell recycle pool 302a, 302b, or 302c can be assigned to store cells for a unique template. When a new cell will be generated for a particular template, a cell can be retrieved from the cell recycle pool 302a, 302b, or 302c corresponding to the desired template. Alternatively or additionally, a single cell recycle pool (e.g., cell recycle pool 302a) can be used to store cells having a variety of cell templates. In this case, a desired cell template can be retrieved from the cell recycle pool by referring to the template identifiers of the cells in the pool.

In some circumstances, the size of a cell can change over time, for example, when a user interacts with the cell on the display. A template for such a cell may enable a user to expand or collapse a subview associated with the cell. Advantageously, when a cell size change occurs, the systems and methods described herein (e.g., using the scrolling module 142) can automatically adjust positions of neighboring cells, as needed, to accommodate the new cell size. This can be done, for example, by calculating new cell positions based on current cells sizes. For example, the scrolling module 142 can move cells with larger or smaller indices up or down according to the updated cell size calculations.

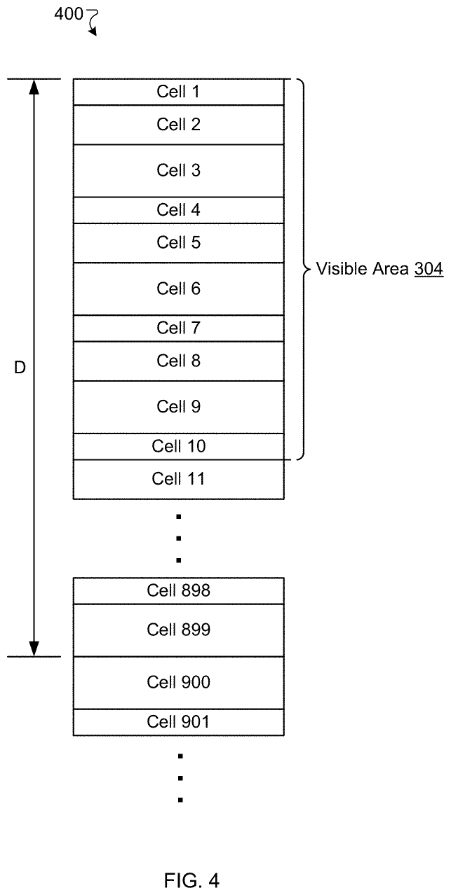

In various examples, the display on a mobile device may be able to present only a small portion of a total number of cells in a cell sequence (e.g., the sequence 300). For example, the cell sequence may include 1000 cells or more, but the display may be large enough to present only about 10 cells at one time. Additionally, it can be desirable in some instances to be able to advance the display (e.g., immediately) to a distant cell location in the sequence, for example, in response to a user request to access the distant cell. For example, referring to FIG. 4, a cell sequence 400 can include 1000 cells, with Cells 1-10 currently residing in the visible area 304 and being presented on a display of a mobile device. When a request is made to advance the display quickly or immediately from cell index 1 to cell index 900, it may be necessary to know a distance D (e.g., a linear distance along the display) from the cell at index 1 to the cell at index 900. Further, to calculate this distance D accurately, it may be necessary to obtain precise cell sizes for all cells from indices 1 to 899. This can require rendering and measuring 899 cells, which can take an exceedingly long time to complete.

It is now recognized, however, that most users can tolerate small errors in the calculation of distance D, such that when the display advances to Cell 900 it is acceptable if the display does not land precisely at a correct location for Cell 900 or at a boundary of Cell 900. To take advantage of this observation, an estimate of the distance D can be calculated based on an average height of a portion of the cells, rather than on precise determinations of all intermediate cell heights. When the display is first loaded, for example, Cells 1-10 have been rendered and the heights of these cells are known or can be readily obtained. An average height h_{avg} for Cells 1-10 can be calculated by adding up the heights for Cells 1-10 and dividing by the number of cells, 10. The estimated distance D can then be determined by multiplying the average height h_{avg} by the number of cells between the desired final cell index (e.g., index 900) and the current initial cell index (e.g., index 1), as follows:

D_{estimated}=h_{avg}(Final Cell Index−Initial Cell Index). (1)

In this example, the estimated distance D is given by 899*h_{avg}, which represents the distance between the top of Cell 1 and the top of Cell 900, as shown in FIG. 4. Accordingly, with this approach, the display can be advanced to an estimated location for Cell 900 by placing Cell 900 at position (0, D), where coordinate “0” represents an x-position (e.g., left to right) on the display, and coordinate “D” represents a y-position (e.g., top to bottom) on the display. Alternatively or additionally, a long scroll area for the display can be advanced to 899*h_{avg}, and Cell 900 can be placed at 899*h_{avg}, such that Cell 900 becomes a first cell in the visible area and appears at a top of the list of displayed cells (e.g., at a window coordinate of (0, D)). Advantageously, the calculation of each of the sizes of the individual Cells 11-899 has been avoided. This optimization technique can significantly improve the speed at which a user can scroll or advance to new locations in a cell sequence. Further, as the user continues to scroll in the view, more cell sizes can be determined and the positions of generated cells can be updated, to account for any errors in the estimated distance D. Additionally or alternatively, the scroll position can be adjusted to make the view look smooth. For example, when cells need to be moved down 50 pixels, a canvas for the display can also be moved up 50 pixels. This can avoid any visible movements or adjustments of cell positions, thereby achieving a smooth visual effect. In such a manner, the systems and methods described herein can support cell sequences or lists of any length. For example, 100,000 cells or more can be handled with only a minor drop in performance.

In various examples, the scrolling module 142 can be implemented in a scripting code (e.g., Lua) or other computer language and/or can be used in instances where there is a need to show a long list, such as, for example, an item store, an options list, a settings list, a message list, an equipment list, etc. In some instances, the scrolling module 142 can support multiple cells in the same row or cell index. Additionally or alternatively, the scrolling module 142 can be used for high level UI systems, such as, for example, RMLBinding and/or MVC. The scrolling module 142 can be used in any suitable type of client application, such as mobile games (e.g., massively multiplayer online (MMO) games) and the like. The scrolling module 142 can be implemented with any appropriate type of computer language, such as, for example, Lua, HTML, Javascript, and the like. Some implementations of the scrolling module 142 can support SCROLLVIEW in RML.

Advantageously, the systems and methods described herein can support cell sequences that have variations in cell size (e.g., cell width and height) and/or can place cells next to each other in indices order. The systems and methods can support dynamic cell size changes, in which the size of a cell can change while the cell is displayed, for example, due to user interaction with the cell. The systems and methods can listen for resize events and can adjust positions of one or more cells after a resize event is received or occurs.

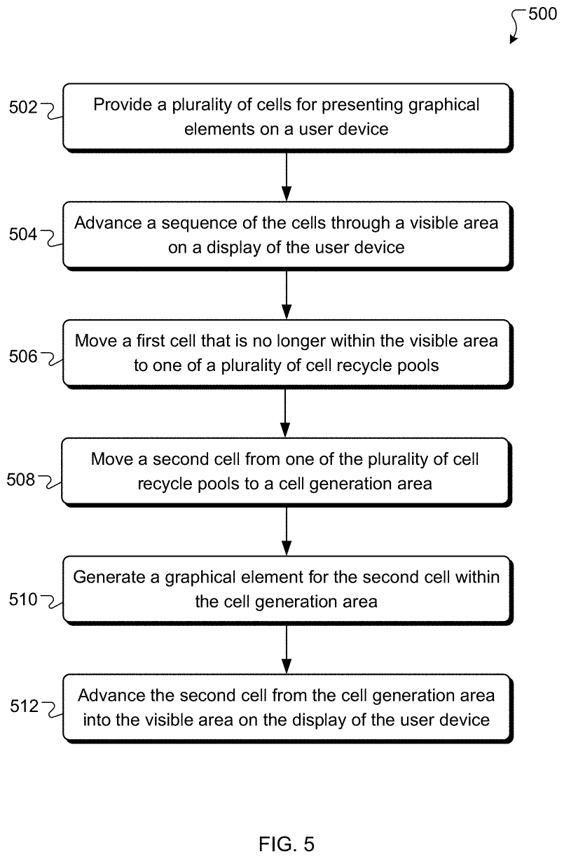

FIG. 5 illustrates an example method 500 of managing a scrolling operation on a display. A plurality of cells is provided (step 502) for presenting graphical elements on a user device (e.g., a mobile device). A sequence of the cells is advanced (step 504) through a visible area on a display of the user device. A first cell that is no longer within the visible area is moved (step 506) to one of a plurality of cell recycle pools. A second cell from one of the plurality of cell recycle pools is moved (step 508) to a cell generation area. A graphical element for the second cell is generated (step 510) within the cell generation area. The second cell is advanced (step 512) from the cell generation area into the visible area on the display of the user device.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing a plurality of cells for presenting graphical elements on a user device;
advancing a sequence of the cells through a visible area on a display of the user device;
moving a first cell that is no longer within the visible area to one of a plurality of cell recycle pools;
moving a second cell from one of the plurality of cell recycle pools to a cell generation area;
generating a graphical element for the second cell within the cell generation area; and
advancing the second cell from the cell generation area into the visible area on the display of the user device.

2. The method of claim 1, wherein the cells comprise multiple templates, each template comprising a unique arrangement of graphical elements;

3. The method of claim 2, wherein each cell recycle pool in the plurality of cell recycle pools corresponds to a respective template from the multiple templates.

4. The method of claim 1, wherein advancing the sequence of the cells comprises:
receiving an instruction from a user of the device to scroll through the cells on the display.

5. The method of claim 1, wherein advancing the sequence of the cells comprises:
presenting a portion of the sequence of the cells on the display.

6. The method of claim 1, wherein the cell generation area is proximate the visible area.

7. The method of claim 6, wherein moving the first cell comprises:
moving the first cell from a recycle area proximate the cell generation area.

8. The method of claim 1, wherein advancing the sequence of cells comprises:
estimating a distance within the sequence of cells to a third cell; and
advancing the sequence of cells through the visible area by the estimated distance.

9. The method of claim 8, wherein estimating the distance comprises:
determining an average height for a subset of cells in the sequence; and
calculating the estimated distance based on the average height.

10. The method of claim 8, wherein advancing the sequence of cells by the estimated distance comprises:
moving the third cell into the visible area on the display.

11. A system, comprising:
one or more computer processors programmed to perform operations comprising:
providing a plurality of cells for presenting graphical elements on a user device;
advancing a sequence of the cells through a visible area on a display of the user device;
moving a first cell that is no longer within the visible area to one of a plurality of cell recycle pools;
moving a second cell from one of the plurality of cell recycle pools to a cell generation area;
generating a graphical element for the second cell within the cell generation area; and
advancing the second cell from the cell generation area into the visible area on the display of the user device.

12. The system of claim 11, wherein the cells comprise multiple templates, each template comprising a unique arrangement of graphical elements;

13. The system of claim 12, wherein each cell recycle pool in the plurality of cell recycle pools corresponds to a respective template from the multiple templates.

14. The system of claim 11, wherein advancing the sequence of the cells comprises:
receiving an instruction from a user of the device to scroll through the cells on the display.

15. The system of claim 11, wherein advancing the sequence of the cells comprises:
presenting a portion of the sequence of the cells on the display.

16. The system of claim 11, wherein the cell generation area is proximate the visible area.

17. The system of claim 16, wherein moving the first cell comprises:
moving the first cell from a recycle area proximate the cell generation area.

18. The system of claim 11, wherein advancing the sequence of cells comprises:
estimating a distance within the sequence of cells to a third cell; and
advancing the sequence of cells through the visible area by the estimated distance.

19. The system of claim 18, wherein advancing the sequence of cells by the estimated distance comprises:
moving the third cell into the visible area on the display.

20. An article, comprising:
a non-transitory computer-readable medium having instructions stored thereon that, when executed by one or more computer processors, cause the one or more computer processors to perform operations comprising:
providing a plurality of cells for presenting graphical elements on a user device;
advancing a sequence of the cells through a visible area on a display of the user device;
moving a first cell that is no longer within the visible area to one of a plurality of cell recycle pools;
moving a second cell from one of the plurality of cell recycle pools to a cell generation area;
generating a graphical element for the second cell within the cell generation area; and
advancing the second cell from the cell generation area into the visible area on the display of the user device.
